(19) United States
(12) Patent Application Publication
(10) Pub. No.: US 2024/0037774 A1
(43) Pub. Date: Feb. 1, 2024

(54) THREE-DIMENSIONAL SCINTILLATION DETECTION TECHNIQUE FOR RADIATION DETECTION

(71) Applicant: Lawrence Livermore National Security, LLC, Livermore, CA (US)

(72) Inventor: Kenneth Edward Gregorich, Bishop, CA (US)

(21) Appl. No.: 17/877,497

(22) Filed: Jul. 29, 2022

(51) Int. Cl. G01T 1/29; G01T 1/20; G01T 1/204; G01T 7/00

(52) U.S. Cl. CPC G01T 1/2928; G01T 1/2018; G01T 1/204; G01T 7/005

(57) ABSTRACT

A technique for determining the three-dimensional position of radiation interaction in a scintillator is disclosed. The method comprises detecting a scintillation event within a scintillator to produce a measured detector response, by using a photodetector that has a planar surface optically coupled to the scintillator and that has a plurality of pixels defined on the planar surface. The method further comprises calculating a spatial distribution of photons, resulting from the scintillation event, across the planar surface of the detector, and determining an angle-dependent quantum efficiency of the photodetector, associated with the scintillation event. The method further comprises calculating a detector response of the photodetector based on the spatial distribution of photons and the angle-dependent quantum efficiency, to produce a calculated detector response; and computing a position in three dimensions of the scintillation event based on the calculated detector response and the measured detector response.

### STATEMENT REGARDING FEDERALLY SPONSORED RESEARCH

This invention was made with Government support under Contract No. DE-AC52-07NA27344 awarded by the United States Department of Energy. The Government has certain rights in the invention.

### TECHNOLOGY FIELD

The present invention generally pertains to scintillation detectors, and more particularly, to a technique for determining the three-dimensional position of radiation interaction in a scintillator.

### BACKGROUND

Scintillation detectors are commonly used to detect radiation for various purposes, such as monitoring for radioactive contamination, medical imaging, radiometric assay, and nuclear plant safety. In state-of-the art position-sensitive scintillation detector systems, highly segmented arrays of individual scintillator elements have been used to achieve two-dimensional (2D) position sensitivity. These systems are inherently complex and expensive, with a state-of-the-art full-body positron emission tomography (PET) system containing upward of 30,000 detector elements. The 2D position resolution is limited to several mm by the size of the detector elements. Some systems have very limited position resolution in the third (depth of interaction) dimension by using layered scintillators.

A method has also been proposed for use of larger monolithic scintillators by coupling to pixelated detectors. However, this approach obtains the point and angle at which a gamma-ray enters the face of the scintillator using a cumbersome and compute-intensive lookup table method. This lookup table method does not measure position resolution in the third (depth of interaction) dimension; it simply corrects for the mean depth of interaction of an ensemble of exponentially-distributed interaction lengths. In yet another approach, -the measured light distributions are simply fit with a set of convenient functions without regard to the true light distribution or detector response.

### BRIEF DESCRIPTION OF THE DRAWINGS

One or more embodiments of the present invention are illustrated by way of example and not limitation in the figures of the accompanying drawings, in which like references indicate similar elements.

FIG. 1A illustrates the geometry of a scintillation event above a planar scintillation detector along with several associated parameters.

FIG. 1B illustrates an example graph of a bivariate Cauchy distribution (BCD).

FIG. 1C illustrates an example graph of an angle-dependent quantum efficiency, QE(θ)

FIG. 2 is a high-level block diagram of a radiation detection system.

FIG. 3 shows an example of an overall process for detecting 3D position of a scintillation event.

FIG. 4 illustrates an example of a multi-sample α-scintillation detector system.

FIG. 5 illustrates an example of a multi-sample β-γ detector system.

FIG. 6 shows a liquid scintillator-based Compton camera.

FIG. 7A is a diagram illustrating two Compton scatters within a Compton camera.

FIG. 7B is a diagram illustrating three Compton scatters within a Compton camera.

FIG. 8 is a flow diagram illustrating a more detailed example of an overall process for 3D position detection of a scintillation event.

FIG. 9 is a flow diagram illustrating an example of a process for generating a BCD*QE(θ) lookup table.

FIG. 10A is a flow diagram illustrating an example of a process for determining initial guesses for source position coordinates, (x₀, y₀, z₀).

FIG. 10B is a flow diagram illustrating an example of a process for determining an initial guess for the number of photons, a₀.

FIG. 11 is a flow diagram illustrating an example of a process for using curve fitting by parabolic interpolation to obtain values of x₀, y₀, z₀ and a₀ for a given scintillation event.

FIG. 12 is a flow diagram illustrating an example of a process for calculating a LLH for the source at the center of a scintillator voxel.

FIG. 13 is a high-level block diagram of a computer system.

### DETAILED DESCRIPTION

Introduced here is an improved method for radiation detection by determination of the position in three dimensions (3D) of scintillation events in a scintillation detector. In at least one embodiment, the method introduced here employs the actual equations for scintillation photon distribution on a planar detector, together with the angle-dependent detector response to those scintillation photons, as described in detail below.

### I. Overview

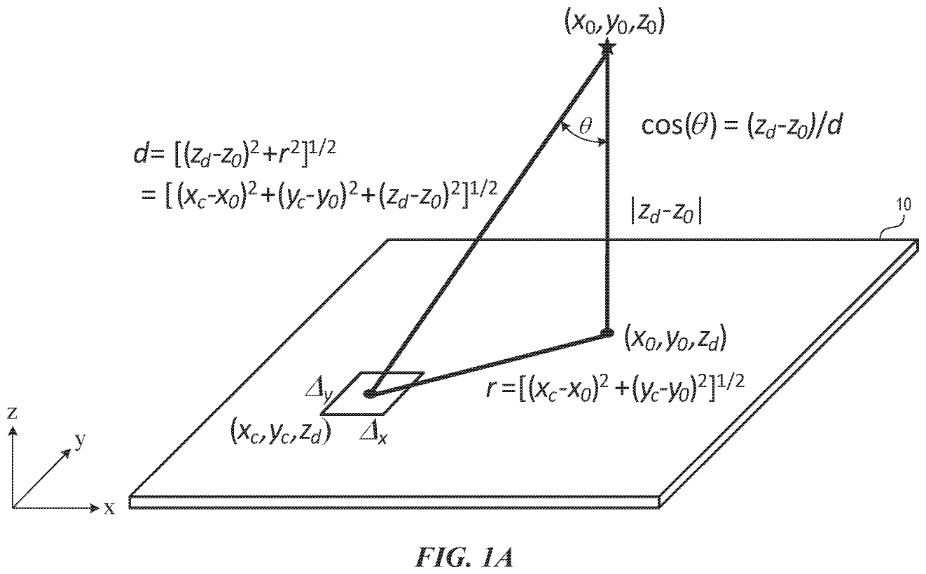

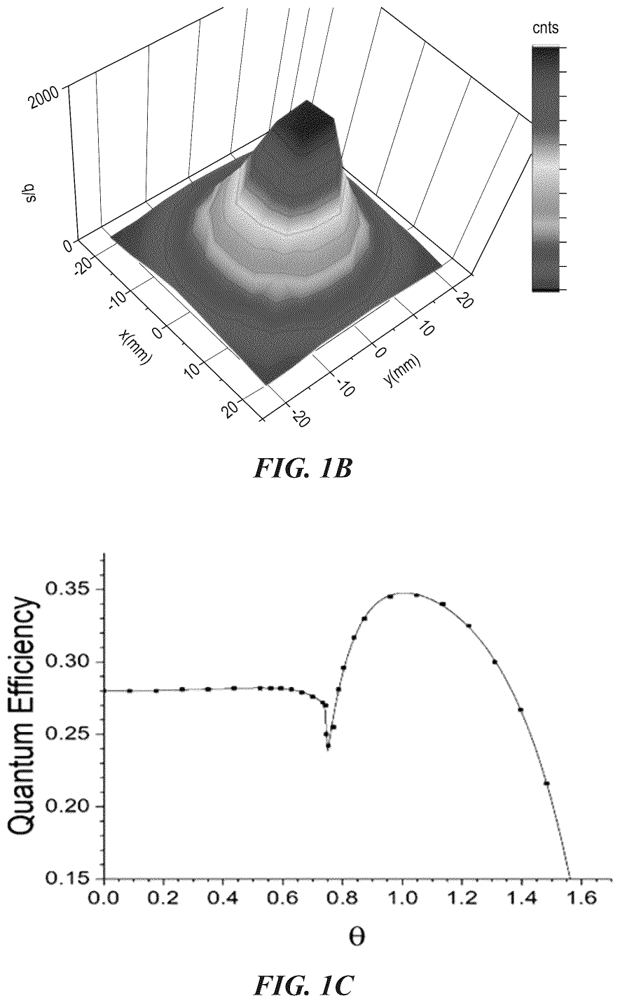

FIG. 1A illustrates the geometry of a planar scintillation detector along with several parameters that are discussed below. Assume that a light source, i.e., a scintillation event, is located at (x₀, y₀, z₀) an demits a₀ photons isotropically. Assume further that the surface of a planar scintillation detector lies in the z=z_{d} plane. The normal distance from the light source to the detector surface is |z−z₀|. The value r is the distance from the base of the normal vector to a detector pixel center, (x_{c}, y_{c}, z_{d}), on the detector surface. The value d is the distance from the light source to a detector pixel center, (x_{c}, y_{c}, z_{d}), on the detector surface. The pixel has dimensions Δₓ×Δ_{y}.

When radioactive decay energy is deposited at some position, (x₀, y₀, z₀), in a scintillator, a decay-energy-dependent number of scintillation photons, a₀, is emitted isotropically from that position. The spatial distribution of those photons hitting a planar detector surface (defined to be at z=z) is a Bivariate Cauchy Distribution (BCD), which can be written as equation (1):

$$BCD ( {a}_{0} , {x}_{c} , {x}_{0} , {y}_{c} , {y}_{0} , {z}_{d} , {z}_{0} ) = \frac{{a}_{0} {Δ}_{x} {Δ}_{y}}{4 π} ( \frac{\vert {z}_{d} - {z}_{0} \vert}{{( {( {x}_{c} - {x}_{0} )}^{2} + {( {y}_{c} - {y}_{0} )}^{2} + {( {z}_{d} - {z}_{0} )}^{2} )}^{3 / 2}} ) , \qquad ( 1 )$$

where (x_{c}y_{c}) are the center of a detector pixel with dimensions Δx′ Δy. An example of a BCD is shown in FIG. 1B. The width of the distribution gives source-to-detector distance. The BCD is similar to a Lorentzian distribution rotated around a line in the z-direction and passing through (x₀, y₀). That means the 2D source position (x₀, y₀) of a source (scintillation event) can be found by determining the centroid of the BCD in x and y. Determining the source z₀ position comes from a measure of the width of the BCD (which is narrow if the source is close to the detector and wide if the source is far from the detector).

Additionally, in accordance with the technique introduced here, for each scintillation event the BCD light intensity distribution is multiplied by the detector response, which is characterized as a quantum efficiency (QE), i.e., the probability of any scintillation photon at the photocathode creating a measurable signal in the detector system. This QE is a function of the angle of incidence, θ, of the scintillation photon, and is therefore referred to as the angle-dependent quantum efficiency, QE(θ). Using the product of BCD*QE(θ) gives the actual equation for what the detector sees. The angle-dependent QE has been studied for standard bialkalai optically-coupled photomultiplier tube photocathodes. For this work, QE(θ) has been fit with a simple two-part function as set forth in equations (2) and (2a), and as illustrated in FIG. 1C:

$$QE ( θ ) = [ \begin{matrix}( 0.0105 {θ}^{2} + 0.28 ) ( 1 - {e}^{- 13.5 ( 0.956 - θ )} ) & θ < 0.75 \\ 0.374 ( 1 - {e}^{- 11. ( θ - 0.656 )} ) ( 1 - {e}^{- 4.47 ( 1.68 - θ )} ) & θ \geq 0.75\end{matrix} ] , \qquad ( 2 )$$

$$where θ = a tan ( \frac{{( {( {x}_{c} - {x}_{0} )}^{2} + {( {y}_{c} - {y}_{0} )}^{2} )}^{1 / 2}}{\vert {z}_{d} - {z}_{0} \vert} ) . \qquad ( 2 a )$$

For each scintillation event, the 3D position (x₀, y₀, z₀) and number of photons, a₀, are determined from the product of the BCD (equation (1)) and the QE(θ) (equation (2)).

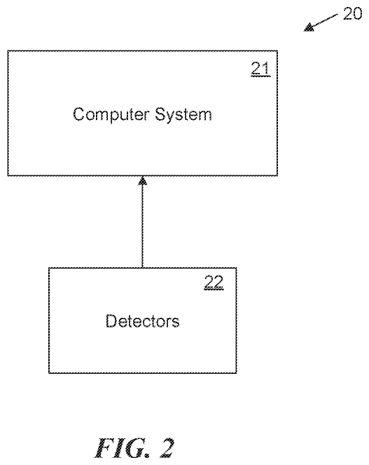

FIG. 2 is a high-level block diagram of a radiation detection system in which the techniques introduced here can be implemented. The system 20 includes one or more scintillation detectors 22, which are coupled to provide their outputs in digital form to a computer system 21. In at least some embodiments, a pair of photomultiplier-based scintillation detectors are used, as discussed further below. The computer system 21 may process the data outputs of the scintillation detectors 22 to determine the 3D position and number of photons associated with each scintillation event. The computer system performs higher level functions, such as image generation, radiation classification, etc., based on the 3D position and number of photons associated with each scintillation event.

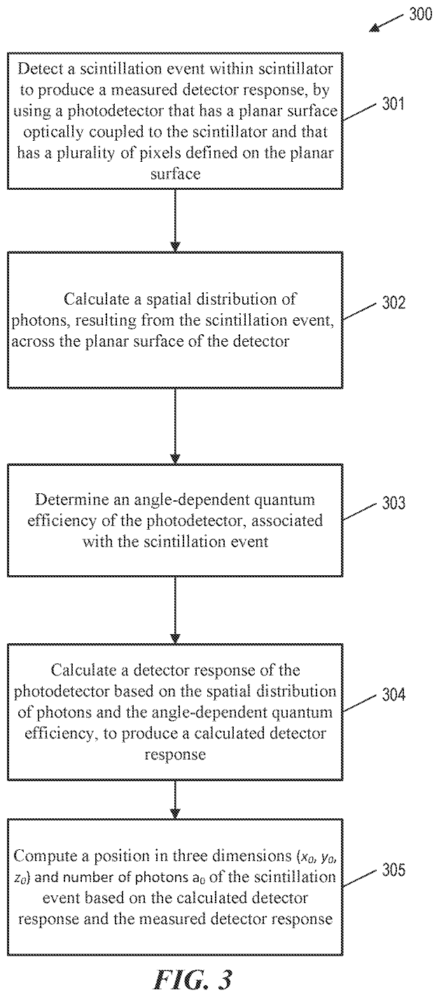

FIG. 3 shows an example of an overall process 300 for detecting the 3D position and number of photons of a scintillation event in accordance with the technique introduced here. The process 300 may be performed by the computer system 21. Initially, at step 301 the process detects a scintillation event within a scintillator to produce a measured detector response, by using a photodetector that has a planar surface optically coupled to the scintillator and that has a plurality of pixels defined on the planar surface. At step 302 the process calculates a spatial distribution of photons, resulting from the scintillation event, across the planar surface of the detector. In at least some embodiments, the spatial distribution is a BCD. At step 303 the process determines the angle-dependent quantum efficiency, QE(θ), of each pixel in the photodetector, associated with the scintillation event. At step 304 the process calculates a detector response of the photodetector based on the spatial distribution of photons and the QE(θ), to produce a calculated detector response. In some embodiments, the detector response is computed as the product of the BCD and the QE(θ) for the scintillation event. At step 305 the process computes a position in three dimensions (x₀, y₀, z₀) and the number of photons a₀ of the scintillation event, based on the calculated detector response and the measured detector response.

### II. Alpha (α) Detection

### A. Simulations of Scintillation Light Distribution and Detector Response

In some embodiments, the 3D position and number of photons a₀ of a scintillation event are determined based on a curve fit of the actual detector response against simulation data. A Monte Carlo computer code for simulation of α-decay liquid scintillation photons and detector response to those photons can be used. The materials for the scintillator, meander channels, glass chamber windows, and glass Multi-Anode PhotoMultiplier Tube (MAPMT) windows (all discussed below) are preferably chosen to have matching refractive indices, to prevent refraction/reflection at theses interfaces. In some embodiments the simulation includes:
1) isotropic emission of a properly-randomized decay-energy-dependent number of scintillation photons from the α-decay position,
2) transport of those photons in the scintillator volume,
3) absorption or diffuse reflection of scintillation photons from the low-reflectivity anodized aluminum scintillator chamber side walls,
4) refraction and specular reflection at the interface between the MAPMT glass window and the bialkalai photocathode, and
5) angle-dependent quantum efficiency in the photocathode.

In some embodiments, simulated sets of BCD*QE(θ) for up to about 10⁷ (or potentially more) α-decay events are created to develop and test data analysis techniques.

### B. Fitting of Simulated Scintillation Light Distribution*Detector Response

To determine the 3D position and number of photons of a scintillation event, Maximum Likelihood fits to the simulated detector response can be performed using the product of equations (1) and (2). The Maximum Likelihood technique finds the optimized set of free parameters, x₀, y₀, z₀, a₀, by comparing experimentally-measured data (or data from the simulation of BCD*QE(θ)) with the expectation values of equation (1) multiplied by equation (2) for each detector pixel calculated with sets of free parameters, x₀, y₀, z₀, a₀. Equation (1) assumes that the number of scintillation photons hitting any part of a detector pixel is the same as that at the center of the pixel. Similarly, equation (2) makes the assumption that the average QE(θ) over an entire detector pixel is the same as that at the center of the pixel. Both of these assumptions lead to inaccuracies in the fit, especially when the source location is near the detector pixel. These fit inaccuracies can be eliminated in the fit by dividing each pixel into many subpixels. While these highly sub-pixelated fits may be compute intensive, they yield favorable results.

One or more simplifications can be applied to speed up the analysis. One such simplification is to replace Δₓ and Δ_{y} in equation (1) with dx and dy, respectively, and double-integrate over the pixel extents, xᵢ, x_{f}, yᵢ, y_{f}, to give a BCD cumulative function, BCDcf, per equation (3):

$$BCDcf ( {a}_{0} , {x}_{i} , {x}_{f} , {x}_{0} , {y}_{i} , {y}_{f} , {y}_{0} , {z}_{d} , {z}_{0} ) = \frac{{a}_{0}}{4 π} ( a tan ( {f}_{1} ) - a tan ( {f}_{2} ) - a tan ( {f}_{3} ) + a tan ( {f}_{4} ) ) , \qquad ( 3 )$$

$$where {f}_{1} = \frac{( {x}_{f} - {x}_{0} ) ( {y}_{f} - {y}_{0} )}{\vert {z}_{d} - {z}_{0} \vert {( {( {x}_{f} - {x}_{0} )}^{2} + {( {y}_{f} - {y}_{0} )}^{2} + {( {z}_{d} - {z}_{0} )}^{2} )}^{1 / 2}} , \qquad ( 3 a )$$

$${f}_{2} = \frac{( {x}_{f} - {x}_{0} ) ( {y}_{i} - {y}_{0} )}{\vert {z}_{d} - {z}_{0} \vert {( {( {x}_{f} - {x}_{0} )}^{2} + {( {y}_{i} - {y}_{0} )}^{2} + {( {z}_{d} - {z}_{0} )}^{2} )}^{1 / 2}} , \qquad ( 3 b )$$

$${f}_{3} = \frac{( {x}_{i} - {x}_{0} ) ( {y}_{f} - {y}_{0} )}{\vert {z}_{d} - {z}_{0} \vert {( {( {x}_{i} - {x}_{0} )}^{2} + {( {y}_{f} - {y}_{0} )}^{2} + {( {z}_{d} - {z}_{0} )}^{2} )}^{1 / 2}} , and \qquad ( 3 c )$$

$${f}_{4} = \frac{( {x}_{i} - {x}_{0} ) ( {y}_{i} - {y}_{0} )}{\vert {z}_{d} - {z}_{0} \vert {( {( {x}_{i} - {x}_{0} )}^{2} + {( {y}_{i} - {y}_{0} )}^{2} + {( {z}_{d} - {z}_{0} )}^{2} )}^{1 / 2}} . \qquad ( 3 d )$$

This simplification eliminates the need for sub-pixelation in the BCD calculation, while sub-pixelation is still used in the calculation of the average QE(θ) over any detector pixel.

Another simplification follows from the observation that the maximum likelihood covariance among any pair of the free parameters is very small. Once initial guesses for the parameters are sufficiently accurate, this lack of covariance allows replacement of a four-parameter fit with four single-parameter fits, which further increases calculation speed.

Further simplification can be achieved by fitting of the x- and y-projected spectra in each of the top and bottom detectors (e.g., totaling 4×8=32 channels), rather than the full set of 128 detector pixels. This simplification increases computation speed by a factor of four, with little loss in position or a₀ information

Still another simplification makes use of six-dimensional lookup tables of BCD QE(θ). By setting a₀ equal to 1, BCD*QE(θ) returns the detector pixel solid angle*MAPMT response, which is effectively the efficiency for that pixel. The source volume (scintillator volume) is divided into a 3-dimensional set of small (0.25 mm) voxels (x₀, y₀, z₀). The MAPMT pixels are treated as three additional dimensions (xₚᵢₓ, yₚᵢₓ, zₚᵢₓ), where zₚᵢₓ simply denotes the bottom or top detector. BCD*QE(θ) is calculated for each detector pixel from each source volume voxel, and stored in the six-dimensional lookup table. When analyzing simulated scintillation photon distributions, initial guesses for the four free parameters, a₀, x₀, y₀, z₀ are calculated according to the method below.

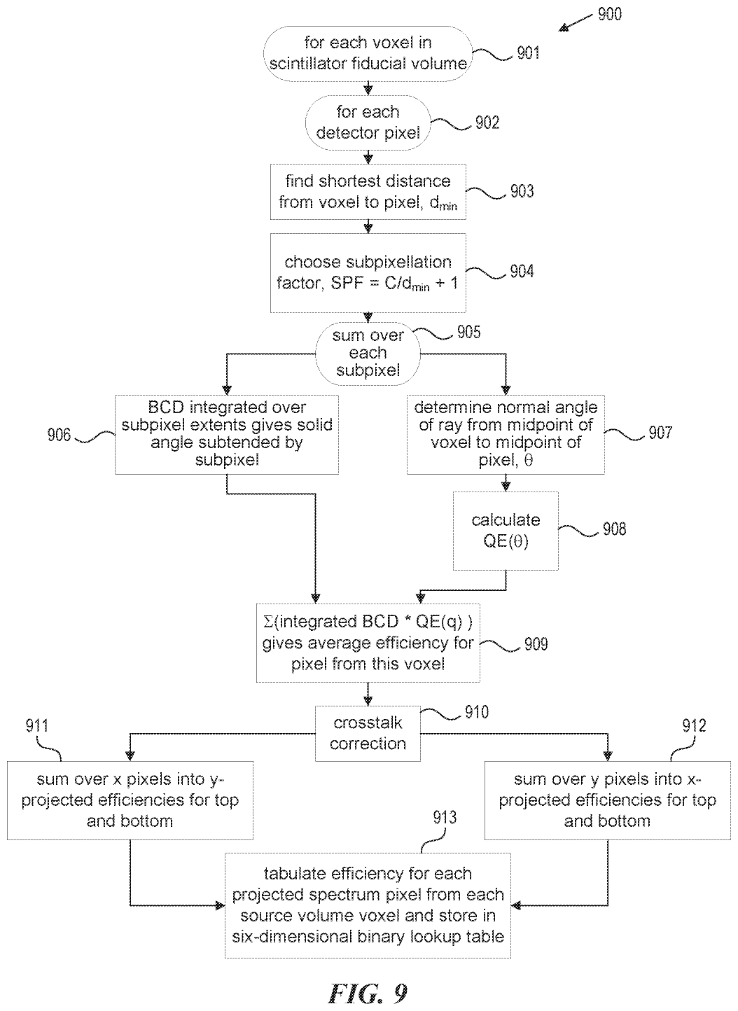

The maximum likelihood goodness of fit for any set of free parameters is calculated as the product over all detector pixels of Poisson probabilities for observing the simulated number of scintillation photons when the expectation value is calculated from a₀ multiplied by the BCD*QE(θ) value found in the lookup table. A one-dimensional search in the lookup table is performed for each free parameter, where the free parameter is determined using a parabolic interpolation around the maximum likelihood peak in that dimension. An example of a process for generating the lookup table is shown in FIG. 9, which is discussed below.

### C. Initial Guesses for the BCD*QE(θ) Fits

To efficiently perform curve-fits to the simulated scintillation photon distributions, initial guesses for the free parameters are used. The technique for determining these initial guesses is dependent on the exact source-detector geometry. The technique described here is for a 24-mm high source volume between a pair of MAPMTs. The summed top and bottom scintillation photon distributions are projected into single-dimensional x-spectra and y-spectra. The weighted average position in these x- and y-projected spectra, x_{wtavg} and y_{wtavg}, respectively, are calculated by weighting each projected spectrum channel centroid by the number of simulated photons detected in that channel. Additionally, a value related to the z-position, z_{wtavg}, of the source is calculated by taking the z-positions of the top and bottom MAPMT photocathodes weighted by the number of scintillation photons detected in top and bottom MAPMTs. Z-dependent scatter in x_{wtavg} and y_{wtavg} is minimized by applying a z_{wtavg}² dependence, resulting in equation (4):

x_{mod}=x_{wtavg}(1−0.0065z_{wtavg}²)y_{mod}=y_{wtavg}(1−0.0065z_{wtavg}²) (4)

Similarly, x- and y-related scatter in z_{wtavg} is minimized with a dependence on the square of the distance from the center of the MAPMT, as per equation (5):

z_{mod}=z_{wtavg}(1−0.0090(x_{wtavg}²+y_{wtavg}²)^{1/2}) (5)

Next, these modified positions are converted to initial guesses, x_{ig}, y_{ig}, z_{ig}, for the distances from the center of the source volume using a 3rd-degree polynomial, where symmetry dictates that the polynomial coefficients of even-order terms are zero, per equations (6) and (7):

x_{ig}=1.63425x_{mod}+0.00193x_{mod}³,y_{ig}=1.63425y_{mod}+0.00193y_{mod}³ (6)

z_{ig}=1.61221z_{mod}+0.00681z_{mod}³ (7)

An initial guess for the number of scintillation photons emitted at the source location, α_{ig}, is found by ignoring the θ-dependence of the quantum efficiency, and replacing it with an average, QEₐᵥₑ=0.3165. A z_{ig} dependence is applied to this QEₐᵥₑ, resulting in equation (8):

QE_{mod}=0.3165(1+0.00546|z_{ig}|−0.000393z_{ig}²) (8)

Finally, a_{ig} estimates for top and bottom MAPMTs are found by dividing the observed number of photons by QE_{mod} and by the BCD integrated over the full detector extent. A weighted average of the estimates from top and bottom detectors is used, per equation (9):

$${a}_{ig} = \frac{\begin{matrix}{{nobs}_{bot}}^{2} / BCDcf ( 1 , {x}_{di} , {x}_{df} , {x}_{ig} , {y}_{di} , {y}_{df} , {y}_{ig} , {z}_{b} , {z}_{ig} ) + \\ {{nobs}_{top}}^{2} / BCDcf ( 1 , {x}_{di} , {x}_{df} , {x}_{ig} , {y}_{di} , {y}_{df} , {y}_{ig} , {z}_{t} , {z}_{ig} )\end{matrix}}{{QE}_{mod} ( {nobs}_{bot} + {nobs}_{top} )} \qquad ( 9 )$$

where x_{di}, x_{df}, y_{di}, and y_{df} are the detector extents, Z_{b} and zₜ are the z-positions of the detector planes, and nobs_{bot} and nobsₜₒₚ are the number of photons detected in the bottom and top detectors, respectively.

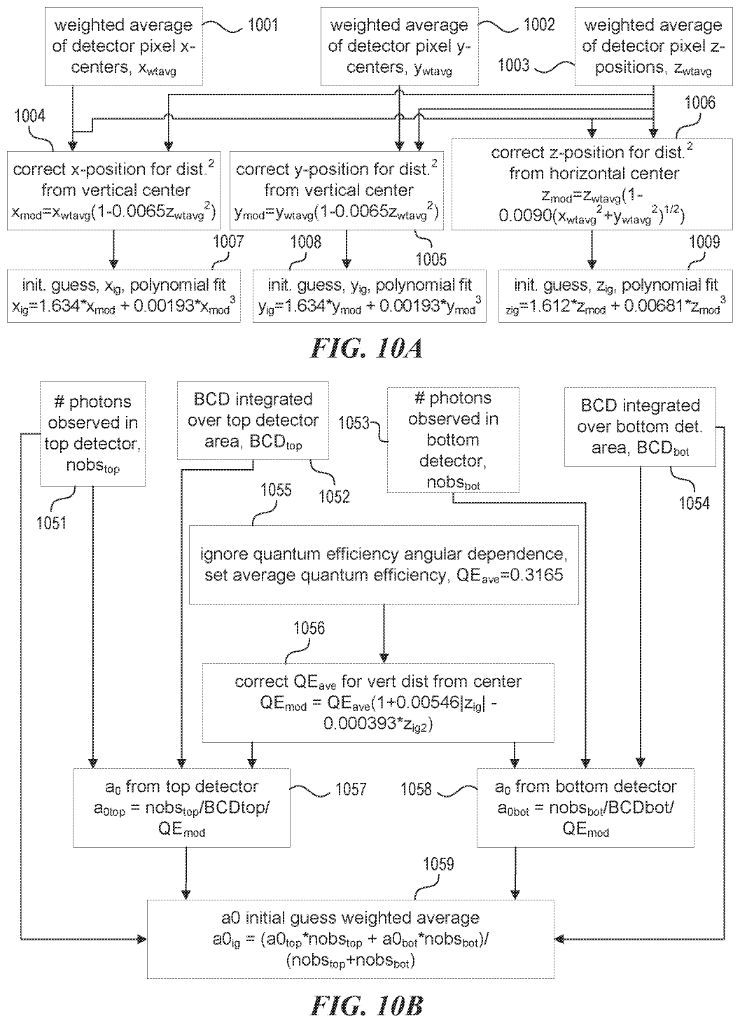

The calculation speed for these initial guess values can be extremely fast, likely limited by the time it takes to read in event data. An example of a process for generating the initial guesses is shown in FIG. 10, which is discussed below.

### D. Calibration

The 3D position-sensitive scintillator technique introduced here can be used to detect α-decays in a liquid scintillator. An α-decay calibration procedure provides the calibrations needed for at least some other applications of the 3D scintillator detector technique, such as positron emission tomography (PET) imaging, Compton camera, and neutron camera applications. The calibration determines the efficiency for each MAPMT pixel from each position in the scintillator. It is also important that this efficiency calibration is performed with exactly the same geometry as that to be used in the measurements.

In at least some embodiments, the calibration is based on the assumption that the MAPMTs being used for detection are of a particular model of MAPMT from a particular manufacture, such as Hamamatsu H12700A MAPMTs, for example. These MAPMTs have an 8×8 array of 6×6 mm² square anodes, resulting in 64 pixels. The response of each anode to scintillation photons can vary by ±25%. This “anode nonuniformity” is a combination of nonuniformities in both quantum efficiency and photomultiplier gain, and a calibration is desired to correct for it. An α-decay tracer activity with a single α peak (and no coincident γ-rays or conversion electrons) in liquid scintillator will be used. Calibration using individual α-decay events is not possible, because (until calibration is complete) the position of any α-decay is unknown. However, the average of a large ensemble of α-decays can be simulated and compared with an experimentally-measured average. In this way, a linear calibration can be created for each MAPMT pixel, where the intercept is the “dark current” background and the slope converts the ADC channel number to a number of scintillation photons detected in that detector pixel.

### E. Detailed Process Flows

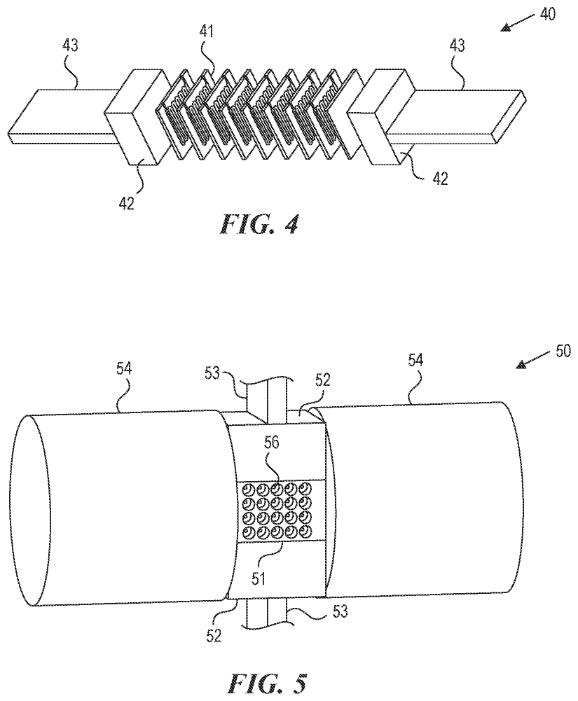

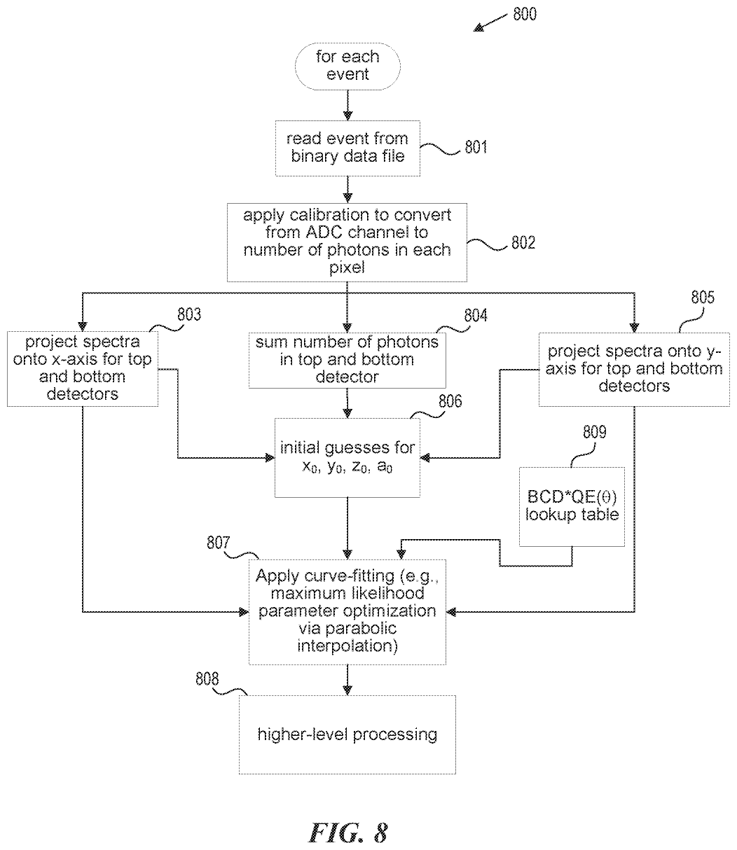

FIG. 8 illustrates in greater detail an example of an overall process for 3D position detection of a scintillation event. Solely for purposes of explanation, it is assumed here that a two-detector configuration such as described above in relation to FIG. 4 is used, in which the two detectors are referred to as the “top” and “bottom” detectors, respectively.

The illustrated process 800 is performed for each scintillation event. Initially, for a given scintillation event, at step 801 the process reads the data of the event from a binary data file. At step 802 the process applies a calibration as discussed above to convert from the ADC channel to the number of photons in each pixel. Next, steps 803, 804 and 805 occur in parallel. At steps 803 and 805, the process projects the spectra from the event onto the x-axis and the y-axis, respectively, for each of the top and bottom detectors. At step 804, the process sums the number of photons detected by the top and bottom detector. After completion of steps 803, 804 and 805, the process determines at step 806 the initial guesses for the parameters, x₀, y₀, z₀, and a₀. Next, the process at step 807 applies a curve fitting technique such as described above (e.g., maximum likelihood parameter optimization via parabolic interpolation) against corresponding values from the BCD*QE(θ) lookup table 809, to determine the actual x₀, y₀, z₀, and a₀ for the scintillation event. Optionally, at step 808, the actual x₀, y₀, z₀, and a₀ for the scintillation event are output to another, higher-level process, such as a process for detecting and classifying alpha decay, an image generation process (e.g., for PET), etc.

FIG. 9 shows an example of the process for generating the BCD*QE(θ) lookup table 809. The process is performed for each detector pixel (902) for each voxel (901) within the scintillator fiducial volume. Initially, at step 903 the process finds the shortest distance, dₘᵢₙ, from the current voxel to the current pixel. At step 904 the process chooses a sub-pixelation factor (SPF), where SPF=Cldₘᵢₙ+1, where C is a constant. Next, at step 905 the process sums over each subpixel, as set forth in steps 906 through 909. Steps 907 and 908 are performed sequentially in parallel with step 906. Specifically, step 906, solid angle subtended by the subpixel is determined by integrating the BCD over the subpixel extents. At step 907, the process determines the normal angle, θ, of the ray from the midpoint of the current voxel to the midpoint of the current sub-pixel. At step 908, the process calculates the quantum efficiency, QE(θ). At step 909 the process sums the products of the integrated BCD and QE(θ) values from steps 906 and 908, respectively, to determine the average efficiency for the current pixel from the current voxel. At step 910 the process optionally performs correction for crosstalk between the MAPMTs. To do this, the process may use, for example, the correction process specified in Calvi et al., “Characterization of the Hamamatsu H12700A-03 R12699-03 Multi-Anode Photomultiplier Tubes,” Journal of Instrumentation. vol. 10, Sep. 29, 2015, which is incorporated by reference herein. After step 910 the process performs steps 911 and 912 in parallel. In step 911, the process sums efficiencies over the x pixels into y-projected efficiencies for the top and bottom detectors. In step 912, the process sums efficiencies over they pixels into x-projected efficiencies for the top and bottom detectors. Finally, at step 913 the process tabulates the efficiency for each projected spectrum pixel from each source volume voxel and stores them in a six-dimensional binary lookup table.

FIGS. 10A and 10B collectively illustrate an example of the details of step 806 from FIG. 8, i.e., determining the initial guesses for x₀, y₀, z₀, and a₀. This example is based on an assumed scintillator volume of −24.5 mm<x, y<24.5 mm and −12 mm<z<12 mm. Figure illustrates determining the initial guesses for the source position coordinates, x₀, y₀, z₀, while FIG. 10B illustrates determining the initial guess for the number of photons, a₀. Referring first to FIG. 10A, the process at steps 1001, 1002 and 1003 inputs, respectively, the weighted average of detector pixel x centers (x_{wtavg}), y centers (y_{wtavg}) and detectors z positions (z_{wtavg}) (i.e., weighted by the numbers of photons detected in each pixel). The weighted averages of detector pixel x centers (x_{wtavg}) and detector pixel y centers (y_{wtavg}) are provided as input to steps 1004 and 1006. The weighted average of detector pixel z positions (z_{wtavg}) is provided as input to steps 1004, 1005 and 1006.

At step 1004 the process corrects the x-position for the distance-squared from the vertical center according to the equation x_{mod}=x_{wtavg}(1−0.0065z_{wtavg}²), and at step 1007 the process determines the initial guess for x₀, x_{ig}, according to the polynomial fit x_{ig}=1.634*x_{mod}+0.00193*x_{mod}³. Similarly, at step 1005 the process corrects the y-position for the distance-squared from the vertical center according to the equation y_{mod}=y_{wtavg}(1−0.0065z_{wtavg}²), and at step 1008 the process determines the initial guess for y₀, y_{ig}, according to the polynomial fit y_{ig}=1.634*y_{mod}+0.00193*y_{mod}³. Similarly, at step 1006 the process corrects the z-position for the distance from the horizontal center according to the z_{mod}=z_{wtavg}(1−0.0090(x_{wtavg}²+y_{wtavg}²)^{1/2}), and at step 1009 the process determines the initial guess for z₀, z_{ig}, according to the polynomial fit z_{ig}=1.612*z_{mod}+0.00681*z_{mod}³.

FIG. 10B illustrates an example of the details of determining the initial guess for the number of photons, a₀. The process of FIG. 10B takes as input the number of photons observed in the top detector, nobsₜₒₚ, (1051); 2) the BCD integrated over the top detector area, BCDₜₒₚ (1052); 3) the number of photons observed in the bottom detector, nobs_{bot} (1053); and 4) the BCD integrated over the bottom detector area, BCD_{bot} (1054). At step 1055, while ignoring the quantum efficiency angular dependence, the process sets the average quantum efficiency, QEₐᵥₑ=0.3165, which is approximately the average QE value in FIG. 1C. The process then at step 1056 corrects QEₐᵥₑ for the vertical distance from center to determine a modified QE value, QE_{mod}=QEₐᵥₑ(1+0.00546|z_{ig}|−0.000393*z_{ig}²). At step 1057, the process calculates a₀ for the top detector as a₀ₜₒₚ=nobsₜₒₚ/(BCDₜₒₚ*QE_{mod}). At step 1058, the process calculates a₀ for the bottom detector as a_{0bot}=nobs_{bot}/(BCD_{bot}*QE_{mod}). Finally, at step 1059, the process computes the overall initial guess a₀ as a weighted average of a₀ₜₒₚ and a_{0bot}.

a_{0ig}=(a₀ₜₒₚ*nobsₜₒₚ+a_{0bot}*nobs_{bot})/(nobsₜₒₚ+nobs_{bot}).

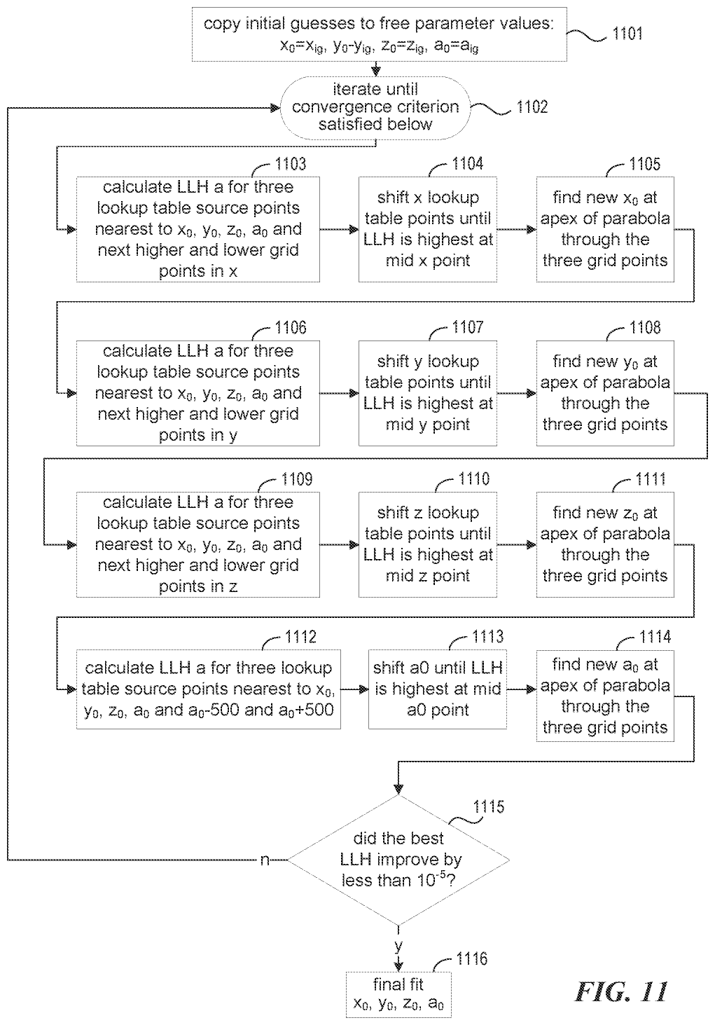

FIG. 11 illustrates an example of the details of step 807 in FIG. 2, i.e., the use of curve fitting by parabolic interpolation to obtain the final values of x₀, y₀, z₀ and a₀ for a given scintillation event. At step 1101 the process sets the free parameter values to the initial guesses, i.e., x₀=x_{ig}, y₀−y_{ig}, z₀=z_{ig}, a₀=a_{ig}. The process then iterates (1102) until a convergence criterion in step 1115 is satisfied.

During a given iteration, the process at step 1103 calculates the log likelihood (LLH) for three lookup table source points nearest to x₀, y₀, z₀, a₀ and the next higher and lower grid points in x. A process for calculating an LLH is described below. At step 1104 the process shifts the x lookup table points until the LLH is highest at the mid x point. At step 1105 the process finds a new x₀ at the apex of a parabola through the three grid points. At steps 1106 through 1108, the process does the same for y₀, and then at steps 1109 through 1111 does the same for z₀.

Next, at step 1112 the process calculates the LLH for the three lookup table source points nearest to x₀, y₀, z₀, a₀ and a₀−500 and a₀+500. The process at step 1113 then shifts a₀ until the LLH is highest at the mid a₀ point. Then at step 1114, the process finds a new a₀ at the apex of the parabola through the three grid points.

Next, at step 1115, if the best LLH during this iteration improved by less than 10⁻⁵, then the current x₀, y₀, z₀ and a₀ values are the final values. Otherwise, the process loops back to 1102 to perform another iteration.

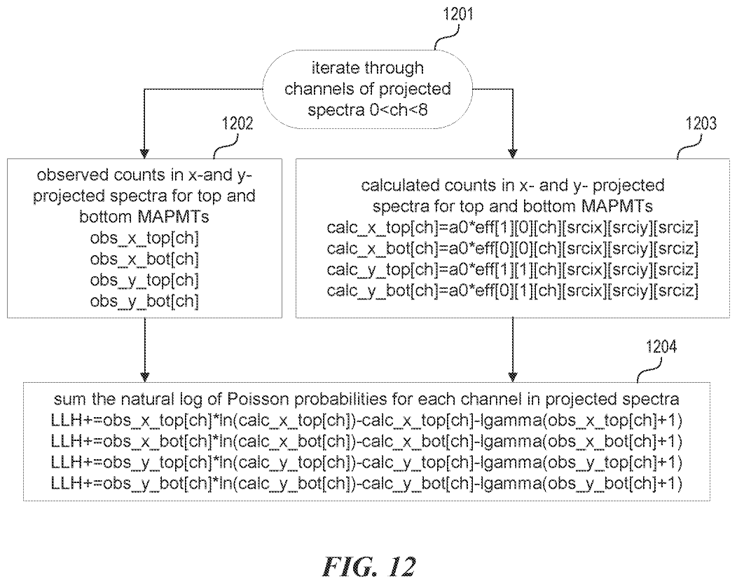

FIG. 12 shows an example of the process of calculating a LLH for the source at the center of a scintillator voxel. A lookup table contains the efficiency from each source volume voxel, (srcix, srciy, srciz), to each projected spectrum channel; this efficiency is denoted as eff[bottom or top det][x or y projection][channel][srcix][srciy][srciz]. The process iterates (step 1201) through each of (in this embodiment) eight channels/MAPMTs, 0<ch<7 for both the x- and y-projected spectra in both the top and bottom detectors. Steps 1202 and 1203 are performed in parallel. In step 1202, for the current channel the process sets the observed counts in the x-and y-projected spectra for the top and bottom MAPMTs as follows:

obs_x_top[ch]

obs_x_bot[ch]

obs_y_top[ch]

obs_y_bot[ch]

In step 1203, for the current channel the process sets the calculated counts in the x- and y-projected spectra for the top and bottom MAPMTs as follows:

calc_x_top[ch]=a₀*eff[1][0][ch][srcix][srciy][srciz]

calc_x_bot[ch]=a₀*eff[0][0][ch][srcix][srciy][srciz]

calc_y_top[ch]=a₀*eff[1][1][ch][srcix][srciy][srciz]

calc_y_bot[ch]=a₀*eff[0][1][ch][srcix][srciy][srciz]

Then at step 1204, to produce the final LLH value for the channel, the process sums the natural log of Poisson probabilities for each channel in the projected spectra as follows, where lgamma(x) is the natural log of the gamma function:

LLH=obs_x_top[ch]*ln(calc_x_top[ch])−calc_x_top[ch]−lgamma(obs_x_top[ch]+1)

LLH=obs_x_bot[ch]*ln(calc_x_bot[ch])−calc_x_bot[ch]−lgamma(obs_x_bot[ch]+1)

LLH=obs_y_top[ch]*ln(calc_y_top[ch])−calc_y_top[ch]−lgamma(obs_y_top[ch]+1)

LLH=obs_y_bot[ch]*ln(calc_y_bot[ch])−calc_y_bot[ch]−lgamma(obs_y_bot[ch]+1)

### III. Multi-Sample Alpha (α) Detector

The above-described position-sensitive technique for detection of α-particles in liquid scintillator allows construction of a detector like that depicted in FIG. 4, which shows an exploded view of a multi-sample α-detector 40 for eight organic scintillator streams. Multiple (e.g., eight) flat glass layers 41 are stacked between two MAPMTs 42, where each MAPMT pixel is coupled to provide its analog output to a separate analog-to-digital converter (ADC) 43, which in turn provides its output to a data processing system (e.g., computer system 21 in FIG. 2). A meander (zig-zag) channel is etched into each layer of glass. Each glass layer has an input port and an output port for injection and outflow of, respectively, the scintillator stream. The glass plates have the same refractive index as liquid scintillator (about 1.5), so the scintillation photons pass from the scintillator to the glass without reflection or refraction, such that they take straight paths to the detector.

In an example use case, α-activity-bearing scintillator solution is passed through the meander channels. 3D position sensitivity such as described above provides information on the meander layer in which a scintillation occurred, and the position within that layer. Specifically, knowing the flow velocity of the scintillator in a meander channel allows one to correlate the (x₀, y₀) position within the layer to a time since entering the channel on that layer (interspersing aqueous solution droplets with the scintillator will result in a slug flow situation, preventing laminar flow mixing of the scintillator). In other words, when the flow rate of scintillator through the meander channels is known, the (x₀, y₀) position of the α-decay can be converted to a time since entering the detector. Determination of the meander layer allows determination of the stream in which the decay occurred. The precise position within the meander layer can be used to determine radioactive decay lifetime. Since the range of 6-MeV α-particles in liquid scintillator is about 53 μm, the meander channels should have a diameter greater than about 1 mm to ensure that more than 95% of the α-particles stop in scintillator, rather than intersecting the meander channel walls.

The multi-layer design of FIG. 4 allows either a) measurement of multiple individual scintillator streams simultaneously (e.g., eight in the illustrated embodiment), or b) connection of the layers in series to allow a larger volume detection for a single stream. That is, with the illustrated embodiment, one can either measure alpha activity from 8 different scintillator streams simultaneously, or connect the layers so a single scintillator stream runs through the glass layers sequentially. The former method may have applications for nuclear forensic chemistry (for example, in response to a dirty bomb scenario, one may have to measure alpha activity on thousands of samples). For the latter, the a activity in a single scintillator stream can be measured for eight times as long with the illustrated embodiment.

For column chromatography, it is usual to collect several sequential samples (fractions) of column effluent, where each fraction is dried, prepared as an a source, and counted individually. With the 3D position-sensitive technique introduced above, it is possible to run the column effluent through the meander channels and use the position (time) information to relate α-decays to column elution position. In post-nuclear-event forensic analysis, it may be necessary to measure hundreds or even thousands of samples after chemical separation. The 3D position-sensitive technique introduced here allows either measurement of several chemical separation streams in parallel, or measurement many of time-sequenced samples in a single chemical stream. In either case, a chemical separation system can be run continuously with no source preparation or source handling between chemical separation and detection.

### IV. Other Applications of the Described 3D Position-Sensitive Technique

### A. Multi-Sample Beta-Gamma (β-γ) Detector

The technique introduced above can be applied and/or extended to be used for monitoring many samples containing β-γ activities. FIG. 5 shows an example of a multi-sample β-γ detector system 50 that can use the 3D positioning technique introduced above. In the illustrated embodiment, FIG. 5 shows a β-γ detector for simultaneously monitoring 20 streams. A plastic scintillator 51 including 20 machined channels 56 is positioned between two MAPMTs 52, each of which is coupled to provide its analog outputs to separate ADCs 53, which in turn provides its output to a data processing system (e.g., computer system 21 in FIG. 2). The channels and MAPMTs are then placed between two Ge γ-ray detectors 54, which are also coupled to the data processing system.

In an example use case, β-γ activities in an aqueous solution are passed through the multiple channels in the plastic scintillator. Since the range of a 500 keV β particle is 1.7 mm, the channel diameters should be on the order of 1 mm, to assure that the β-particles can pass through the aqueous liquid and deposit most of their energy in the plastic scintillator. Once again, the 3D position resolution as described above allows determination of the channel in which the β-particle was emitted. With flow rate information, the time since entering the channel can be determined. With addition of Ge γ-ray detectors, as shown in FIG. 5, β-γ coincidence information can be used to identify the decaying nuclide.

In a laboratory setting, a detector such as depicted in FIG. 5 allows simultaneous β-γ coincidence measurement of multiple samples, with minimal source preparation. This multi-sample detector technology will facilitate post nuclear event forensic analysis, where hundreds or even thousands of samples must be analyzed.

### B. PET Imaging

In positron emission tomography (PET), the subject being imaged contains a positron emitter, such as ¹⁸F. The positrons annihilate with electrons, creating a pair of 511 keV gamma rays emitted in opposite directions. Detecting both 511 keV γ-rays in a position-sensitive detector array defines a line of response (LOR) on which the positron annihilation occurred. The positron source can be imaged as the intersection of several of these LORs. State-of-the-art full body (80-cm diameter) PET imagers achieve position resolution using highly segmented arrays of scintillator crystals. They often contain upwards of 30,000 individual crystals, resulting in a complex and expensive apparatus. The image resolution is limited by three main effects: 1) positron travel before annihilation into two 511 keV gammas, 2) non-collinearity of the 511 keV gammas, and 3) detector position resolution.

PET imaging simulations for an 80-cm diameter “full body” imager show that positron travel contributes about 1 mm FWHM to the image blur. Similarly, non-collinearity of the 500 keV gamma rays contributes ˜1 mm FWHM to the image blur. With 5×5 cm² detector elements in a state-of-the-art PET imager, detector position resolution contributes 2.5 mm FWHM to the image blur. Adding these image blur contributions in quadrature results in a state-of-the-art theoretical-best image resolution with FWHM=2.9 mm. For source locations off the central axis of the detector system, there is also a parallax contribution, widening the resolution FWHM further.

By using monolithic scintillators (liquid, plastic, or CaF2) with the position-sensitive detection technique introduced above, the position of the first interaction (Compton scatter) for each 511 keV gamma can be determined with improved resolution. The detector resolution will contribute less to the image blur, resulting in improved image resolution. Position resolution in the depth-of-interaction dimension eliminates the parallax error contribution.

Use of this 3D position-sensitive scintillation detector technique, therefore, has the potential to provide better PET image resolution in a system with significantly reduced complexity at a greatly reduced cost.

### C. Compton Camera

A Compton camera is typically comprised of two position-sensitive γ-ray detectors, a scatterer and an absorber. A gamma ray can Compton-scatter in the scatterer imparting some of its energy to a Compton electron which is detected in the scatterer. The energy of resulting Compton-scattered gamma-ray can then be detected by the absorber. When the positions and energies of a Compton-scatter in the scatterer and the first interaction in the absorber are known, the Compton scattering law can be used to define a Compton cone on which the gamma-ray originated. The apex of the cone is at the interaction site in the scatterer, the axis of the cone is on the line connecting the interaction points in the scatterer and absorber, and the opening angle of the cone is determined by the Compton scattering law. Detection of several scatterer-absorber events results in several of these Compton cones, the intersections of which can be used to create an image of the gamma-ray source.

There are many limitations on Compton camera performance: a) efficiencies for scatterer-absorber events are low, b) determining the first (of possibly many) interaction point in the absorber can be difficult, c) the size of detector elements limits the angular resolution, and d) the orbital motion of electrons in the scatterer and absorber leads to a “Doppler broadening” of the computed Compton angle.

The Compton scattering law is a mathematical relation between four parameters about a scattering center: the γ ray scattering angle (θ) and the energies of the incoming γ-ray (E_{γi}), the Compton electron (E_{ce}), and the Compton-scattered gamma ray (E_{γf}). The Compton scattering equations (10) below can be re-arranged so that if any two of the four parameters are known, the other two can be solved for.

$${E}_{γ f} = \frac{{E}_{γ i}}{1 + \frac{{E}_{γ i}}{{m}_{e} \cdot {c}^{2}} ( 1 - cos ( θ ) )} , {E}_{γ i} = {E}_{ce} + {E}_{γ f} \qquad ( 10 )$$

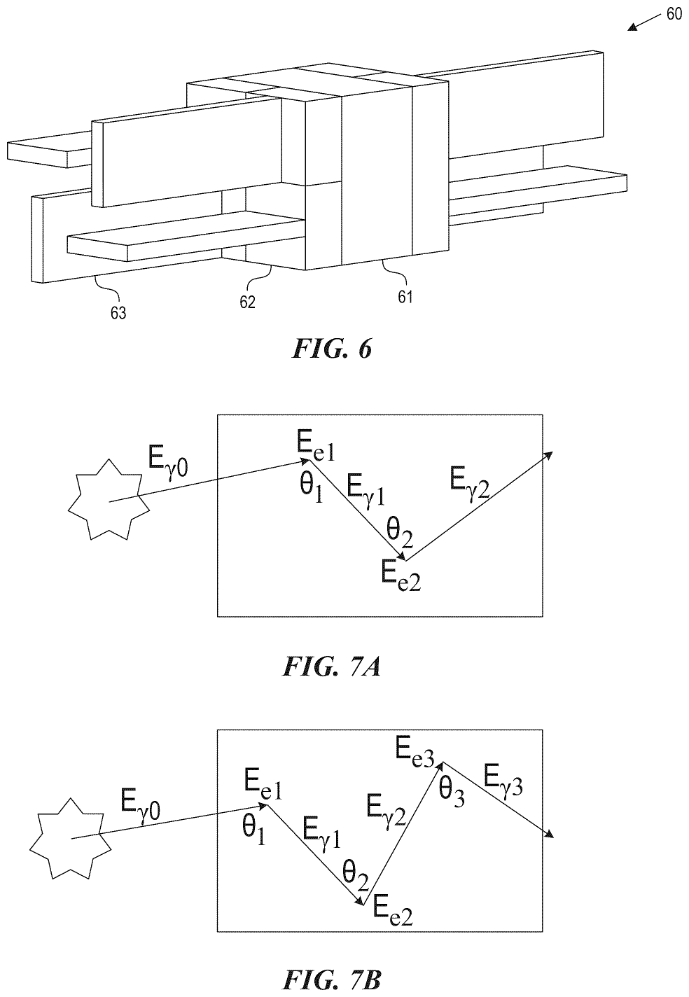

A liquid scintillator-based Compton camera 60 is shown schematically in FIG. 6. In the illustrated embodiment it includes a 0.5-liter liquid scintillator volume 61 sandwiched between eight MAPMTs 62 (four on each side), each of which is coupled to provide analog outputs from each pixel to a separate ADC 63, each of which in turn provides its output to a data processing system (e.g., computer system 21 in FIG. 2). When a γ-ray passes through the scintillator volume, measurement of the positions and energies of Compton electrons from multiple Compton scatters can be used to define the Compton Cone of the first Compton scattering interaction, allowing Compton camera imaging of an external source.

In a situation where the energy of the γ-ray entering the Compton camera is known, the Compton cone can be found when two Compton scatters occur within the detector volume (FIG. 7A). When the incoming γ-ray energy is not known, three Compton scatters inside the detector volume (FIG. 7B) are used to solve the needed Compton scatter equations.

The illustrated Compton camera system will have similar angular resolution and improved efficiency relative to known existing Compton cameras. Further, the detector setup is much simpler and less expensive.

### D. Neutron Camera

The same principles as used for Compton camera imaging can be used to image a neutron source, based on the locations and energies multiple of n-p scattering centers. The same detector as that described for the Compton camera (FIG. 6) can be used. When a fast neutron scatters off of a proton in the scintillator, there are four parameters involved: the neutron scattering angle (θ) and the energies of the incoming neutron (Eₙᵢ), the scattered proton (Eₚ), and the scattered neutron (E_{nf}). The neutron scattering equations (11) below can be re-arranged so that if any two of the four parameters are known, the other two can be solved for.

E_{nf}=Eₙᵢ·cos(θ)²,Eₙᵢ=Eₚ+E_{nf} (11)

Similar to the Compton camera, when the positions and energies of three n-p scatters are detected in the scintillator volume, these equations can be solved for the cone containing the initial neutron source location. With detection of several such neutron cones, their intersections can be used to image the neutron source.

### E. Simultaneous Compton and Neutron Camera

In liquid scintillator, standard pulse-shape discrimination techniques can be used to distinguish between neutron and gamma interactions in the scintillator. The scintillation light is produced with fast- and slow-decaying components, where the MAPMT pulses from neutron scatters have a larger slow-decaying component than pulses from Compton scatters. With pulse-shape discrimination, a single liquid scintillation detector, such as shown in FIG. 6, can be used for simultaneous Compton camera and neutron camera imaging.

### V. Example Computer System

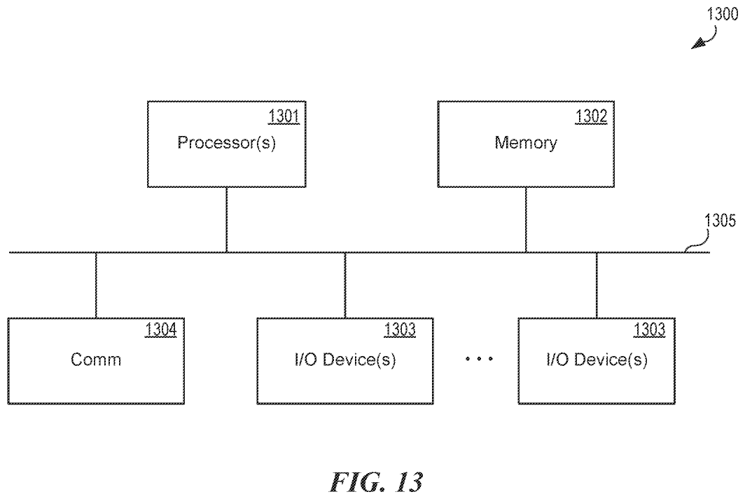

FIG. 13 is a high-level block diagram of a computer system in which at least a portion of the technique disclosed herein can be implemented, including determination of the 3D position and number of photons of each scintillation event. The computer system 1300 in FIG. 13 may represent the computer system 21 in FIG. 2. The computer system 1300 includes one or more processors 1301, one or more memories 1302, one or more input/output (I/O) devices 1303, and one or more communication interfaces 1304, all connected to each other through an interconnect 3105. The processors 1301 control the overall operation of the computer system 100, including controlling its constituent components. The processors 1301 may be or include one or more conventional microprocessors, programmable logic devices (PLDs), field programmable gate arrays (FPGAs), application-specific integrated circuits (ASICs), etc. The one or more memories 1302 stores data and executable instructions (e.g., software and/or firmware), which may include software and/or firmware for performing the techniques introduced above. The one or more memories 1302 may be or include any of various forms of random access memory (RAM), read-only memory (ROM), volatile memory, nonvolatile memory, or any combination thereof. For example, the one or more memories 1302 may be or include dynamic RAM (DRAM), static RAM (SDRAM), flash memory, one or more disk-based hard drives, etc. The I/O devices 1303 provide access to the computer system 1300 by human user, and may be or include, for example, a display monitor, audio speaker, keyboard, touch screen, mouse, microphone, trackball, etc. The communications interface 104 enables the computer system 1300 to communicate with one or more external devices (e.g., an AM fabrication machine and/or one or more remote computers) via a network connection and/or point-to-point connection. The communications interface 104 may be or include, for example, a Wi-Fi adapter, Bluetooth adapter, Ethernet adapter, Universal Serial Bus (USB) adapter, or the like. The interconnect 1305 may be or include, for example, one or more buses, bridges or adapters, such as a system bus, peripheral component interconnect (PCI) bus, PCI extended (PCI-X) bus, USB, or the like.

Unless contrary to physical possibility, it is envisioned that (i) the methods/steps described herein may be performed in any sequence and/or in any combination, and that (ii) the components of respective embodiments may be combined in any manner.

The machine-implemented operations described above can be implemented by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), system-on-a-chip systems (SOCs), etc.

Software or firmware to implement the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

Any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and that (ii) the components of respective embodiments may be combined in any manner.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method comprising:
detecting a scintillation event within a scintillator to produce a measured detector response, by using a photodetector that has a planar surface optically coupled to the scintillator and that has a plurality of pixels defined on the planar surface;
calculating a spatial distribution of photons, resulting from the scintillation event, across the planar surface of the detector;
determining an angle-dependent quantum efficiency of the photodetector, associated with the scintillation event;
calculating a detector response of the photodetector based on the spatial distribution of photons and the angle-dependent quantum efficiency, to produce a calculated detector response; and
computing a position in three dimensions of the scintillation event based on the calculated detector response and the measured detector response.

2. The method of claim 1, wherein calculating the spatial distribution of photons comprises determining a bivariate Cauchy distribution.

3. The method of claim 1, further comprising:
computing a number of photons associated with the scintillation event based on the calculated detector response and the measured detector response.

4. The method of claim 1, wherein the computing a position in three dimensions of the scintillation event comprises performing an iterative curve fit between the calculated detector response and the measured detection response.

5. The method of claim 1, further comprising using the computed position in three dimensions of the scintillation event and a computed number of photons associated with the scintillation event to ascertain characteristics of a decay event of a radioactive particle.

6. The method of claim 1, further comprising using the computed position in three dimensions of the scintillation event and a computed number of photons associated with the scintillation event to detect an alpha decay event.

7. The method of claim 1, further comprising using the computed position in three dimensions of the scintillation event and a computed number of photons associated with the scintillation event to detect a beta-gamma decay event.

8. The method of claim 1, further comprising using the computed position in three dimensions of the scintillation event and a computed number of photons associated with the scintillation event to generate an image of an internal structure of a body.

9. The method of claim 1, wherein the scintillator is a liquid scintillator, the method further comprising passing the liquid scintillator through a channel arranged within a detection range of the photodetector.

10. The method of claim 1, wherein the scintillator is a liquid scintillator, the method further comprising passing each of a plurality of samples of the liquid scintillator through a different one of a plurality of channels that are arranged parallel to each other within a detection range of the photodetector.

11. The method of claim 1, wherein the method is performed in a system that uses a plurality of photodetectors to detect scintillation events, the method further comprising:
applying a calibration to the measured detector response to determine a number of photons in each pixel of the plurality of pixels;
projecting scintillation spectra onto each of a first axis and a second axis of two orthogonal axes for each photodetector of the plurality of photodetectors;
forming an initial guess for the position in three dimensions of the scintillation event based on the projected scintillation spectra;
summing a number of photons detected by the plurality of photodetectors for the scintillation event;
forming an initial guess for the number of photons associated with the scintillation event, based on the summed number of photons;
determining a final value of the position in three dimensions of the scintillation event and the number of photons associated with the scintillation event by performing a maximum likelihood parameter optimization via parabolic interpolation based on the initial guess for the position in three dimensions of the scintillation event and the initial guess for the number of photons associated with the scintillation event.

12. The method of claim 11, wherein applying the calibration comprises:
performing a simulation of a detector response of the photodetector to compute a number of photons per decay for each pixel of the plurality of pixels;
using the photodetector to perform a calibration measurement of a radioactive decay;
using the calibration measurement of a radioactive decay to compute a channel output per decay for each pixel of the plurality of pixels;
using the photodetector to perform a calibration measurement of random trigger events;
computing a slope value as a first one of the set of calibration values based on the number of photons per decay for each pixel and the channel output per decay for each pixel; and
assigning a y-intercept value as a second one of the set of calibration values, based on the calibration measurement of random trigger events.

13. The method of claim 1, further comprising:
generating a set of calibration values for determining a number of photons associated with the calibration event, wherein generating the set of calibration values includes:
performing a simulation of a detector response of the photodetector to compute a number of photons per decay for each pixel of the plurality of pixels;
using the photodetector to perform a calibration measurement of a radioactive decay;
using the calibration measurement of a radioactive decay to compute a channel output per decay for each pixel of the plurality of pixels;
using the photodetector to perform a calibration measurement of random trigger events;
computing a slope value as a first one of the set of calibration values based on the number of photons per decay for each pixel and the channel output per decay for each pixel; and
assigning a y-intercept value as a second one of the set of calibration values, based on the calibration measurement of random trigger events.

14. A radiation detection system comprising:
a plurality of photodetectors, each of the photodetectors having a planar surface optically coupled to a carrier of a liquid or aqueous scintillator, each of the photodetectors further having a plurality of pixels defined on its planar surface; and
a processing system coupled to receive outputs of the plurality of photodetectors, wherein the processing system is configured to perform operations that include:
detecting a scintillation event within a scintillator, by using the plurality of photodetector, to produce a measured detector response;
calculating a spatial distribution of photons, resulting from the scintillation event, across the planar surface of each detector of the plurality of photodetectors;
determining an angle-dependent quantum efficiency of each photodetector of the plurality of photodetectors, associated with the scintillation event;
calculating a detector response of each photodetector of the plurality of photodetectors, based on the spatial distribution of photons and the angle-dependent quantum efficiency associated with that photodetector, to produce a calculated detector response; and
computing a position in three dimensions of the scintillation event and a number of photons associated with the scintillation event, based on the calculated detector response and the measured detector response for each photodetector of the plurality of photodetectors.

15. The radiation detection system of claim 14, wherein calculating the spatial distribution of photons comprises determining a bivariate Cauchy distribution.

16. The radiation detection system of claim 14, wherein the computing a position in three dimensions of the scintillation event comprises performing an iterative curve fit between the calculated detector response and the measured detection response.

17. The radiation detection system of claim 14, wherein said operations further comprise using the computed position in three dimensions of the scintillation event and a computed number of photons associated with the scintillation event to ascertain characteristics of a decay event of a radioactive particle.

18. The radiation detection system of claim 14, wherein said operations further comprise using the computed position in three dimensions of the scintillation event and a computed number of photons associated with the scintillation event to detect an alpha decay event.

19. The radiation detection system of claim 14, wherein said operations further comprise using the computed position in three dimensions of the scintillation event and a computed number of photons associated with the scintillation event to detect a beta-gamma decay event.

20. The radiation detection system of claim 14, wherein said operations further comprise using the computed position in three dimensions of the scintillation event and a computed number of photons associated with the scintillation event to generate an image of an internal structure of a body.

21. The radiation detection system of claim 14, wherein said operations further comprise:
applying a calibration to the measured detector response to determine a number of photons in each pixel of the plurality of pixels;
projecting scintillation spectra onto each of a first axis and a second axis of two orthogonal axes for each photodetector of the plurality of photodetectors;
forming an initial guess for the position in three dimensions of the scintillation event based on the projected scintillation spectra;
summing a number of photons detected by the plurality of photodetectors for the scintillation event;
forming an initial guess for the number of photons associated with the scintillation event, based on the summed number of photons;
determining a final value of the position in three dimensions of the scintillation event and the number of photons associated with the scintillation event by performing a maximum likelihood parameter optimization via parabolic interpolation based on the initial guess for the position in three dimensions of the scintillation event and the initial guess for the number of photons associated with the scintillation event.

22. The radiation detection system of claim 21, wherein applying the calibration comprises:
performing a simulation of a detector response of a photodetector of the plurality of photodetectors, to compute a number of photons per decay for each pixel of the plurality of pixels;
using the photodetector to perform a calibration measurement of a radioactive decay;
using the calibration measurement of a radioactive decay to compute a channel output per decay for each pixel of the plurality of pixels;
using the photodetector to perform a calibration measurement of random trigger events;
computing a slope value as a first one of the set of calibration values based on the number of photons per decay for each pixel and the channel output per decay for each pixel; and
assigning a y-intercept value as a second one of the set of calibration values, based on the calibration measurement of random trigger events.

23. The radiation detection system of claim 14, wherein said operations further comprise:
generating a set of calibration values for determining a number of photons associated with the calibration event, wherein generating the set of calibration values includes:
performing a simulation of a detector response of a photodetector of the plurality of photodetectors, to compute a number of photons per decay for each pixel of the plurality of pixels;
using the photodetector to perform a calibration measurement of a radioactive decay;
using the calibration measurement of a radioactive decay to compute a channel output per decay for each pixel of the plurality of pixels;
using the photodetector to perform a calibration measurement of random trigger events;
computing a slope value as a first one of the set of calibration values based on the number of photons per decay for each pixel and the channel output per decay for each pixel; and
assigning a y-intercept value as a second one of the set of calibration values, based on the calibration measurement of random trigger events.

24. A non-transitory machine-readable storage medium storing instructions, execution of which in a processing system causes the processing system to perform operations comprising:
accessing data indicative of a scintillation event that occurred within a scintillator, as at least a portion of a measured detector response, the data having been acquired by use of a photodetector that has a planar surface optically coupled to the scintillator and that has a plurality of pixels defined on the planar surface;
calculating a spatial distribution of photons, resulting from the scintillation event, across the planar surface of the detector;
determining an angle-dependent quantum efficiency of the photodetector, associated with the scintillation event;
calculating a detector response of the photodetector based on the spatial distribution of photons and the angle-dependent quantum efficiency, to produce a calculated detector response; and
computing a position in three dimensions of the scintillation event and a number of photons associated with the scintillation event based on the calculated detector response and the measured detector response based on the calculated detector response and the measured detector response.

25. The non-transitory machine-readable storage medium of claim 24, wherein calculating the spatial distribution of photons comprises determining a bivariate Cauchy distribution.

26. The non-transitory machine-readable storage medium of claim 24, wherein the computing a position in three dimensions of the scintillation event comprises performing an iterative curve fit between the calculated detector response and the measured detection response.

27. The non-transitory machine-readable storage medium of claim 24, wherein the operations further comprise using the computed position in three dimensions of the scintillation event and a computed number of photons associated with the scintillation event to ascertain characteristics of a decay event of a radioactive particle.

28. The non-transitory machine-readable storage medium of claim 24, wherein the operations further comprise using the computed position in three dimensions of the scintillation event and a computed number of photons associated with the scintillation event to detect an alpha decay event.

29. The non-transitory machine-readable storage medium of claim 24, wherein the operations further comprise using the computed position in three dimensions of the scintillation event and a computed number of photons associated with the scintillation event to detect a beta-gamma decay event.

30. The non-transitory machine-readable storage medium of claim 24, wherein the operations further comprise using the computed position in three dimensions of the scintillation event and a computed number of photons associated with the scintillation event to generate an image of an internal structure of a body.

31. The non-transitory machine-readable storage medium of claim 24, wherein the operations further comprise:
applying a calibration to the measured detector response to determine a number of photons in each pixel of the plurality of pixels;
projecting scintillation spectra onto each of a first axis and a second axis of two orthogonal axes for the photodetector;
forming an initial guess for the position in three dimensions of the scintillation event based on the projected scintillation spectra;
summing a number of photons detected by the photodetector for the scintillation event;
forming an initial guess for the number of photons associated with the scintillation event, based on the summed number of photons;
determining a final value of the position in three dimensions of the scintillation event and the number of photons associated with the scintillation event by performing a maximum likelihood parameter optimization via parabolic interpolation based on the initial guess for the position in three dimensions of the scintillation event and the initial guess for the number of photons associated with the scintillation event.

32. The non-transitory machine-readable storage medium of claim 31, wherein applying the calibration comprises:
performing a simulation of a detector response of the photodetector to compute a number of photons per decay for each pixel of the plurality of pixels;
using the photodetector to perform a calibration measurement of a radioactive decay;
using the calibration measurement of a radioactive decay to compute a channel output per decay for each pixel of the plurality of pixels;
using the photodetector to perform a calibration measurement of random trigger events;
computing a slope value as a first one of the set of calibration values based on the number of photons per decay for each pixel and the channel output per decay for each pixel; and
assigning a y-intercept value as a second one of the set of calibration values, based on the calibration measurement of random trigger events.

33. The non-transitory machine-readable storage medium of claim 24, further comprising:
generating a set of calibration values for determining a number of photons associated with the calibration event, wherein generating the set of calibration values includes:
performing a simulation of a detector response of the photodetector to compute a number of photons per decay for each pixel of the plurality of pixels;
using the photodetector to perform a calibration measurement of a radioactive decay;
using the calibration measurement of a radioactive decay to compute a channel output per decay for each pixel of the plurality of pixels;
using the photodetector to perform a calibration measurement of random trigger events;
computing a slope value as a first one of the set of calibration values based on the number of photons per decay for each pixel and the channel output per decay for each pixel; and
assigning a y-intercept value as a second one of the set of calibration values, based on the calibration measurement of random trigger events.
